(19) United States
(12) Patent Application Publication
(10) Pub. No.: US 2002/0078214 A1
(43) Pub. Date: Jun. 20, 2002

(54) Method and system for controlling a load on a computer

(76) Inventors: Kousuke Shindou, Yokohama (JP); Masao Sato, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/963,934

(22) Filed: Sep. 25, 2001

(30) Foreign Application Priority Data
Dec. 20, 2000 (JP) 2000-391830

(51) Int. Cl. G06F 15/16

(52) U.S. Cl. 709/229

(57) ABSTRACT

Embodiments of the invention are directed to a control method and a control system for controlling a load on a second system such as a server computer. Upon receiving a service initiation request from a first system, a control system determines a load level of the load on the second system. Based upon the load level of the load on the second system, the control system generates a ticket which contains an identifier associated with the service initiation request from the first system and a service initiation period during which service can be provided by the second system to the first system. The control system sends this ticket to the first system to notify the first system of the service initiation time so that access to the second system can be balanced without overloading.

### CROSS-REFERENCES TO RELATED APPLICATIONS

This application is related to and claims priority from Japanese Patent Application No. 2000-391830, filed Dec. 20, 2000, the disclosure of which is incorporated herein by reference.

### BACKGROUND OF THE INVENTION

The present invention relates to computers and computer systems. More specifically, in a method for using the hardware resources of another computer by a user computer or client computer, the present invention relates to a computer control technology for improving the handling of concentrated access to the computer.

Concentrated requests to a computer are generally avoided by having the computer reject requests or by increasing the number of computers and distributing the requests across the computers. If multiple requests are received by a computer, a reservation can be made for a request operation. The reserved operation can be performed when the load on the computer is lighter, or reserved operations can be given priority at a specified time.

The World Wide Web has seen a growing number of users in recent years. High performance is demanded from computers performing the processing for services provided over the Web. However, predicting the number of user requests is virtually impossible and preparing a computer that is adequate for large numbers of concentrated requests or periods of concentrated requests is difficult. Even when computers are made available for distributing requests, there can be a reduction in responsiveness or, in the worst case, a shutdown, if the load exceeds the processing capacity due to a larger than expected number of requests. If requests are processed through reservations, the user makes the reservations so there is no problem when a request is sent. However, reservations cannot be made for requests in which services are used without making reservations.

### BRIEF SUMMARY OF THE INVENTION

Embodiments of the present invention are directed to a computer control method for distributing accesses to a computer and a device therefor.

According to specific embodiments, the present invention generates an identifier associated with a newly received service initiation request. The present invention refers to this identifier information as a ticket ID. The ticket ID is then associated with information indicating a time period during which service can be reliably provided in response to the request. The present invention refers to the ticket ID and the information associated with the service initiation time as a ticket. In the present invention, a ticket refers to information and does not refer to a number written on paper or the like. By sending this ticket to the end user, the end user can be notified of the service initiation time so that access to the server site can be balanced.

In accordance with an aspect of the invention, a control method for controlling a load on a second system comprises receiving a service initiation request from a first system, and determining a load level of the load on the second system in response to the service initiation request from the first system. Based upon the load level of the load on the second system determined in response to the service initiation request from the first system, a ticket is generated. The ticket contains an identifier associated with the service initiation request from the first system and a service initiation period during which service can be provided by the second system to the first system.

In accordance with another aspect of the invention, a control system comprises a ticket issuing module that generates a ticket containing an identifier associated with a first service initiation request received from a first system and a service initiation period during which service can be provided by a second system to the first system. The system further comprises a ticket control module that allows service initiation for the first system with the second system when a second service initiation request is received from the first system with the identifier associated with the first service initiation request during the service initiation period.

In specific embodiments, the service initiation period is selected to reduce overloading the second system to a load level beyond a permissible load level. The ticket may be sent to the first system as a cookie. The first system may be a user system such as a terminal, while the second system may be a server system such as a service computer. The ticket generating information may be stored as a ticket generating history that can be used for performance upgrade of the second system.

The distribution of accesses to a computer can also be achieved through a program that implements these functions or through a recording medium storing such a program.

### BRIEF DESCRIPTION OF THE DRAWINGS

FIG. 1 is a diagram showing the basic architecture of a ticket control mechanism in a client/server system according to an embodiment of the present invention.

FIG. 2 is a diagram showing the architecture of modules in a ticket control mechanism according to an embodiment of the present invention.

FIG. 3 is a flow diagram of the operations performed by a service provider system and a ticket control mechanism according to an embodiment of the present invention.

FIG. 4 is a diagram showing the architecture of another embodiment of the present invention used on the Web.

FIG. 5 is a diagram showing the conventional operations of a terminal on the Web.

FIG. 6 is a diagram showing the operations of a terminal on the Web according to an embodiment of the present invention.

FIG. 7 is a diagram showing an architecture using a telephone according to another embodiment of the invention.

### DETAILED DESCRIPTION OF THE INVENTION

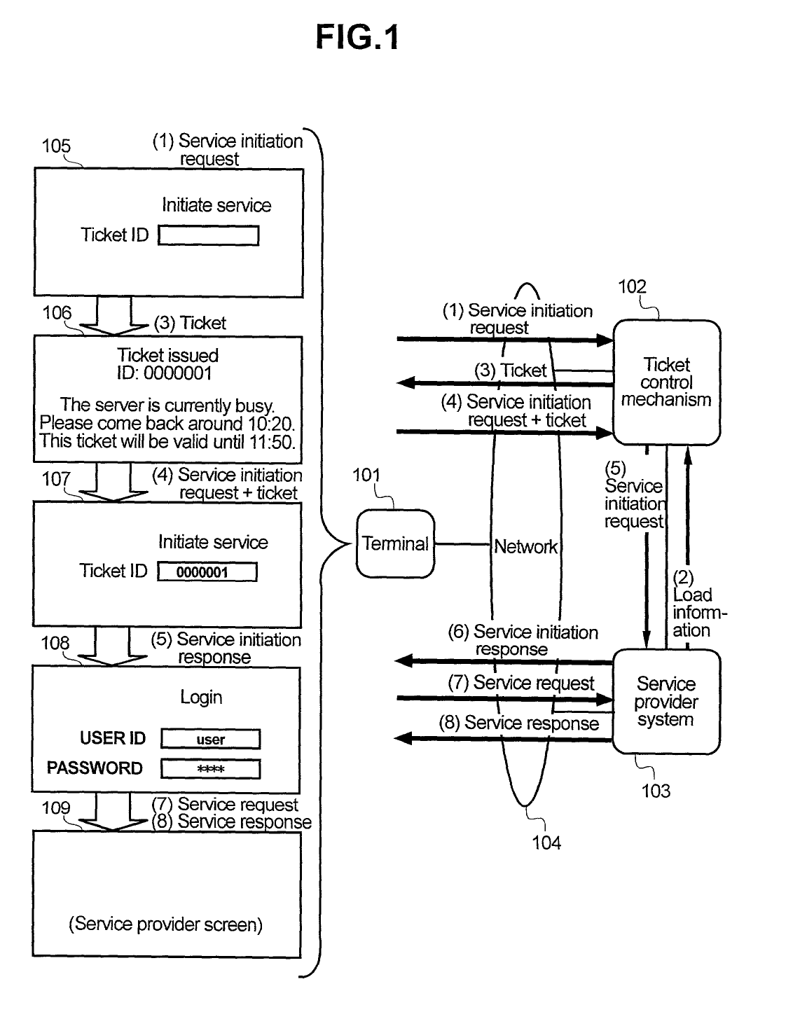

FIG. 1 shows the architecture of a client/server system on a standard network according to an embodiment of the present invention. The client/server system includes a first system such as a terminal 101 serving as a client or user computer, a second system such as a service provider system 103 operating on the server side, and a network 104 connecting the two. A ticket control mechanism 102 serving as the load balancing mechanism of the present invention is also included. Screen images on the terminal 101 are shown in screens 105-109. In general, the first system 101 may be a user or client, a user computer or terminal, a first process, a first program, or the like. The second system 103 may be a service provider or a server, a server computer or system, a second process, a second program, or the like.

When the terminal 101 displays the screen 105, a service initiation request (1) is sent. The ticket control mechanism 102 receives the service initiation request (1) from the terminal 101 and retrieves load information (2) from service provider system 103. A ticket (3) is issued to the terminal 101 according to ticket issuing status and load. If the load is low, the service provider system 103 sends a service initiation request (5). If the load is high, the terminal 101 receiving the ticket (3) displays the screen 106 and prevents overloading of the service provider system 103 by waiting until an indicated time to make the request.

At the end of the indicated time, terminal 101 displays the screen 107 and sends the server computer a service initiation request to which the ticket is attached [hereinafter request plus ticket (4)]. Ticket control mechanism 102 receives request plus ticket (4) from the terminal 101 and checks the ticket for consistency or validity. This involves confirming that the ticket ID is correct, checking whether the request was sent at the indicated time, and the like. If the ticket is not consistent or invalid, an error message is returned. If the ticket is consistent or valid, a service initiation request (5) is sent to the service provider system 103. In response to the service initiation request, the service provider system 103 replies with a service initiation response (6). The terminal 101 displays the screen 108 and authenticates the service provider system 103. Then, the terminal 101 displays the screen 109 and is able to request and receive services (7) (8) from the service provider system 103.

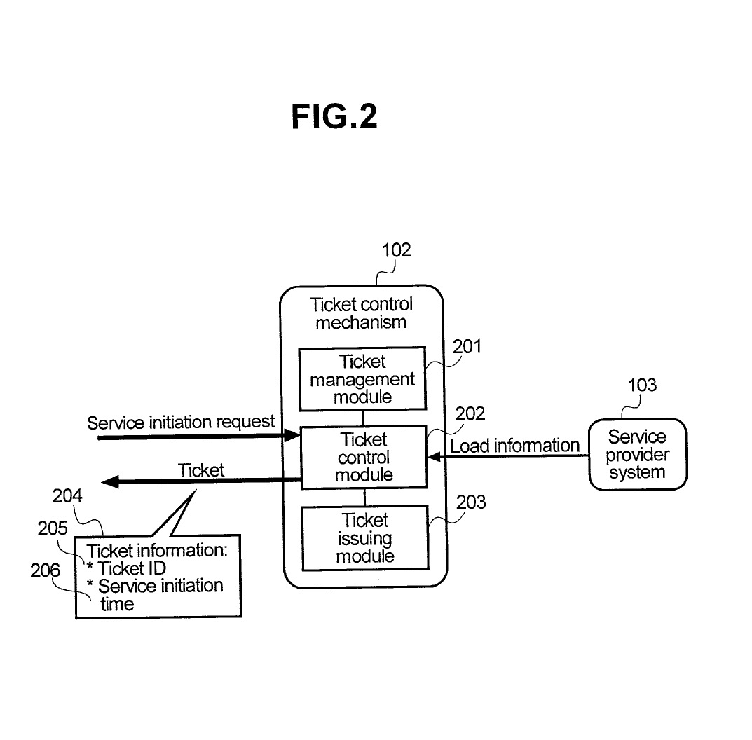

The ticket control mechanism 102 as shown in FIG. 2 includes a ticket management module 201, a ticket control module 202, and a ticket issuing module 203. The ticket issuing module 203 generates ticket information 204. The ticket information 204 contains a service initiation time 206, indicating the time that service can be provided to a terminal, and the like.

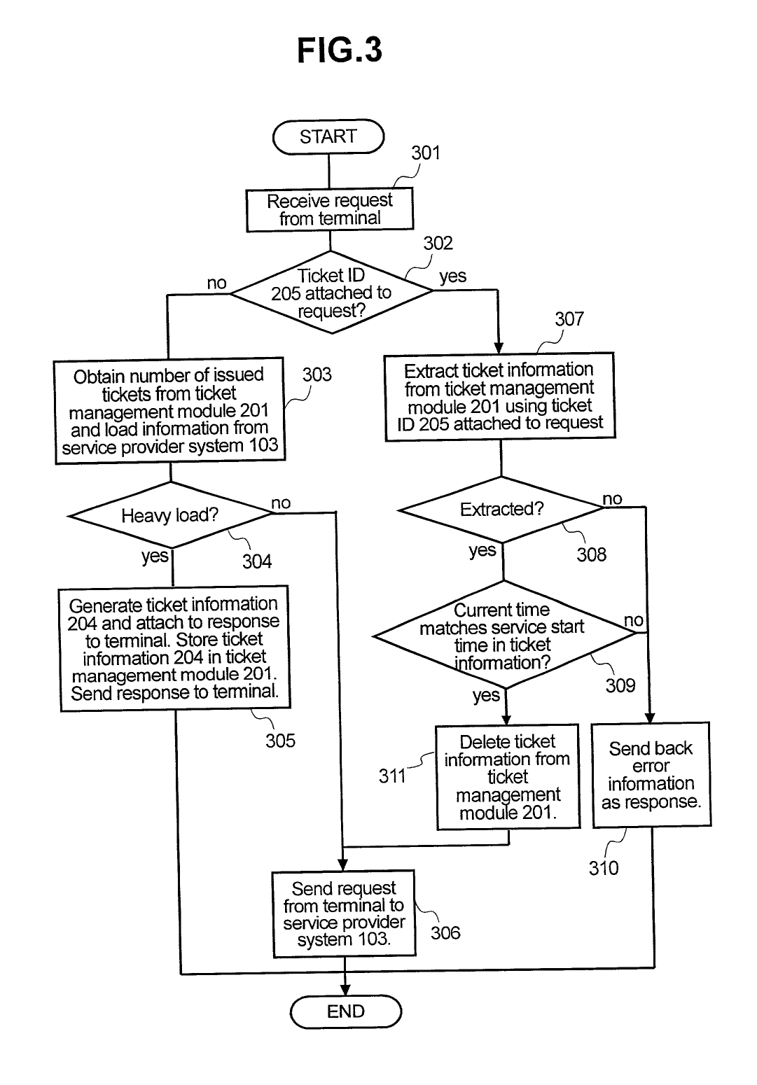

The flow of operations performed by the ticket control mechanism 102 is now described with reference to FIG. 3. At step 301, a service initiation request is received from the terminal. At step 302, the service initiation request is checked to see if a ticket ID 205 is attached. If a ticket ID is attached, control proceeds to step 307. If no ticket ID is attached, control proceeds to step 303 where the number of tickets already issued is retrieved from the ticket management module 201 and computer load information is retrieved from the service provider system 103. At step 304, the information from step 303 is used to determine whether the service provider system is encountering a heavy load (e.g., if the load level is above a preset threshold level such that providing access to the requesting terminal 101 would overload the service provider system 103 beyond a permissible load level). If the load is light (e.g., if the load level is below the preset threshold level), control proceeds to step 306. If the load is heavy, control proceeds to step 305 where ticket information 204 is generated and attached to the response to the terminal. The service initiation time in the ticket information 204 is determined using past statistics on service processing time, queuing theory, and the like. The ticket information 204 stores the ticket management module 201. The ticket management module 201 can store the information using a primary storage device, a secondary storage device, a database, or the like. At step 306, the request from the terminal is sent to the service provider system 103.

At step 307, the ticket information in the ticket ID 205 attached to the request is retrieved from the ticket management module 201. At step 308, the ticket management module 201 is checked to see whether the ticket information for the ticket ID 205 is stored. If no ticket information for the ticket ID 205 is stored, control proceeds to step 310. Otherwise, control proceeds to step 309 where the current time is checked to see if it matches the service initiation time in the ticket information retrieved from the ticket management module 201. If there is a match, control proceeds to step 311 where the ticket information retrieved at step 307 is deleted from the ticket management module 201. Otherwise, control proceeds to step 310, where an error message is sent to the terminal as a response.

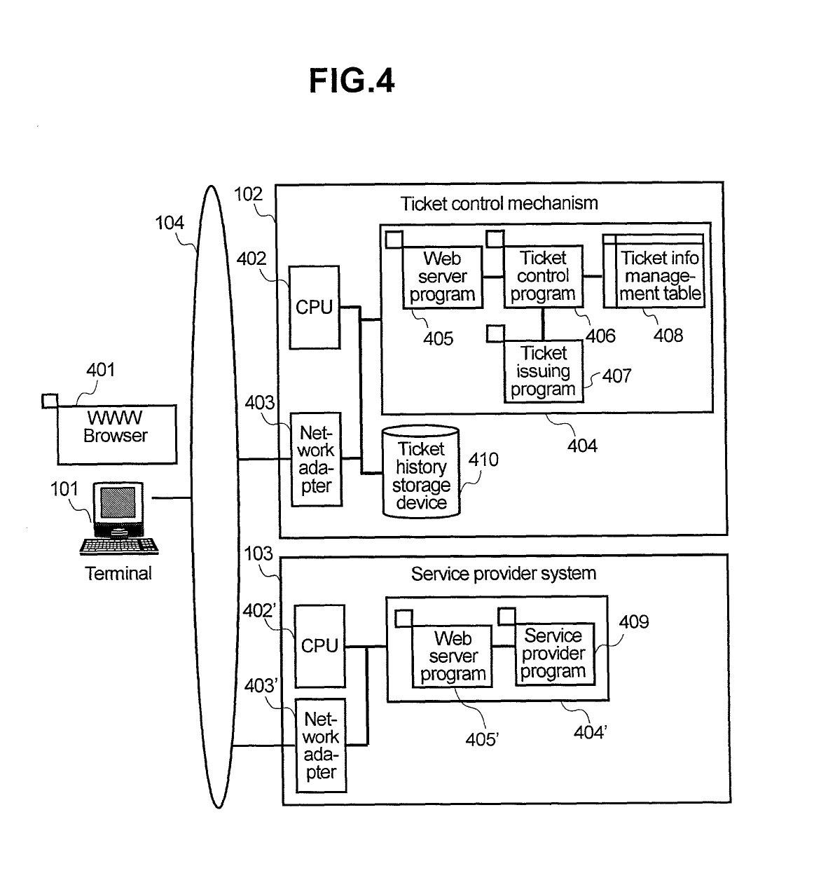

Next, a second embodiment in which the present invention is implemented for the World Wide Web is described. FIG. 4 shows the architecture of the present invention implemented for the Web. A web browser program 401 runs on the terminal 101. In an example in which the ticket control mechanism 102 is implemented on a computer operating on the Web, the ticket control mechanism 102 includes a CPU 402 executing a program, a network adapter 403 providing a connection to a network 104, a memory 404 storing a program, and a ticket history storage device 410. The ticket history storage device 410 accumulates ticket issuing history. The ticket history storage device 410 is optional. The memory 404 of the ticket control mechanism 102 contains a web server program 405, a ticket control program 406, a ticket issuing program 407, and a ticket information management table 408.

In an example in which the service provider system 103 is implemented on a computer operating on the Web, the service provider system 103 includes CPU 402′, network adapter 403′, and memory 404′. The memory 404′ of the service provider system 103 contains the web server program 405′ and a service provider program 409. The ticket control program 406 implements the ticket management module 201 and ticket control module 202 for the Web. The ticket control program 406 generates ticket pages that can be accessed using a web browser. The ticket issuing program 407 is a program that implements the ticket issuing module 203 for the Web. The service provider program 409 is a service application that provides services over the Web. In this embodiment, the computer for the ticket control mechanism 102 and the computer for the service provider system 103 are separate, but it would also be possible to implement these in a single machine.

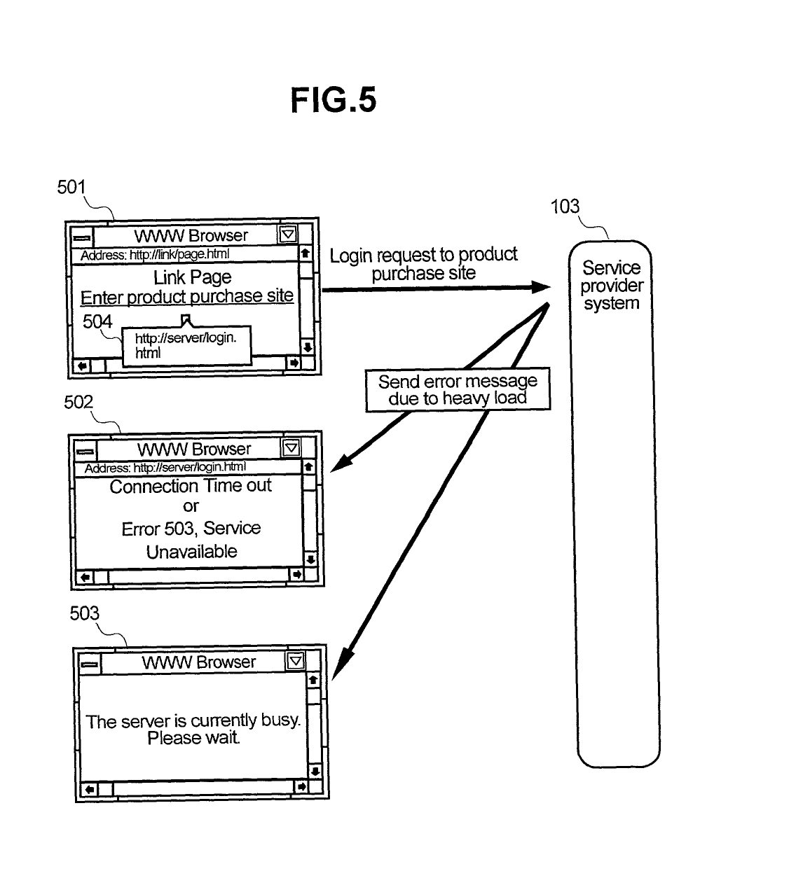

The standard operations performed on the Web if the service provider system 103 is under a heavy load is now described with reference to FIG. 5. Screens 501-503 show sample screen images on the web browser 401 running on the terminal 101. If the service provider system 103 is under a heavy load when a login request to a product purchase site is sent by way of a login request link 504 of the product purchase site on the screen 501, the number of requests is limited in order to protect the service provider system 103.

The request limiting method may involve queuing requests or restricting the number of requests by not receiving additional requests. If queuing is performed, there will be no response from the service provider system. In this no-response state, the terminal 101 will not be able to determine whether the service provider system is halted or if the request has been queued. If requests are restricted, a request will be blocked from the server site and the screen 502 or the screen 503 will be displayed. The terminal 101 will display a rejection message, but the user will be unable to obtain information about when the service can be received. This may result in the user's sending a large number of unnecessary requests in hope of receiving the service, thus increasing server site processing and traffic; or the user may give up on the service. In the case of websites that provide commercial contents for a store or the like, the user of the terminal 101 would be a customer. If a commercial website experiences a heavy load, the reduced responsiveness will decrease the number of clients trying to visit the site, and will reduce the responsiveness for clients who are able to connect to the service, as well. This can reduce the number of customers and sales. Moreover, if the system shuts down or the like, information relating to customers receiving services at the time, e.g., shopping basket information, can be lost. The loss of information relating to important customers can lead to a significant loss for the merchant operating the commercial website.

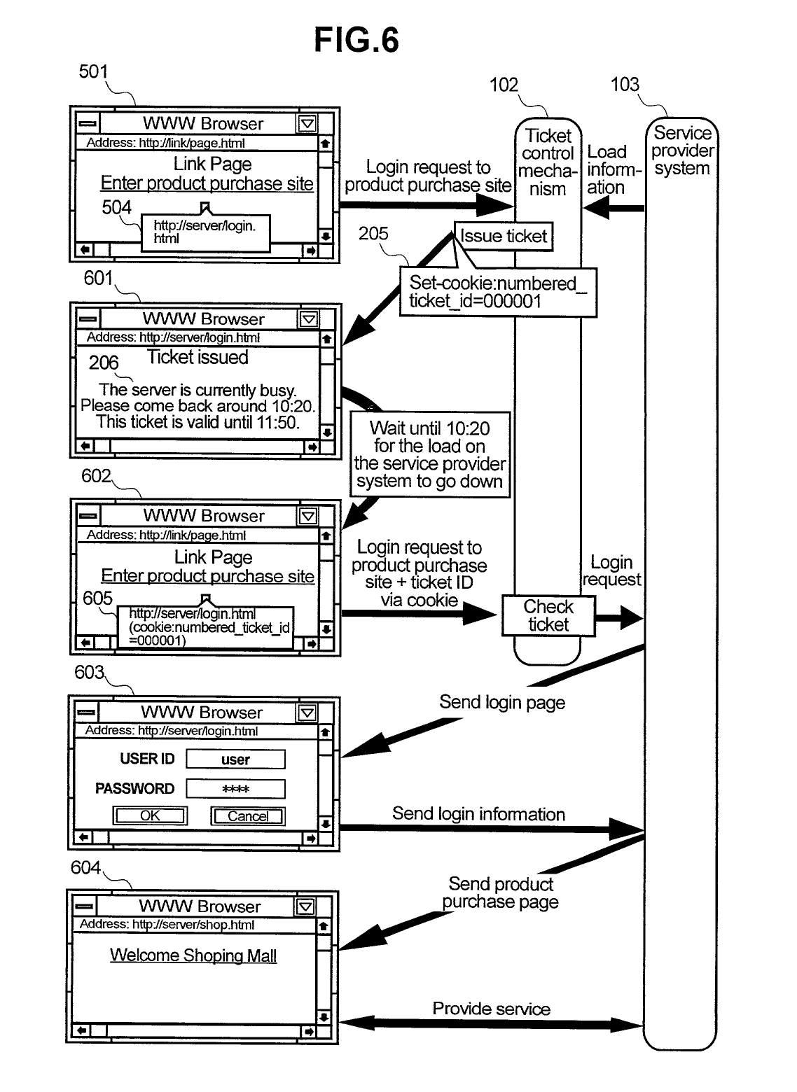

An example of operations performed on the Web by the present invention is now described with reference to FIG. 6. Screen 501 and screen 601-604 show sample screen images on the web browser 401 running on the terminal 101. If the service provider system is under a heavy load when a login request to a product purchase site is sent by way of a login request link 504 of the product purchase site on the screen 501, the ticket control mechanism 102 issues a ticket. For Web use, one method for obtaining load information is to use a Layer 5 or Layer 7 load balancer.

Instead of obtaining load information from the service provider system 103, a Layer 5 or Layer 7 load balancer can be used so that a request to the ticket control mechanism 102 is sent only if the service provider system 103 is experiencing a heavy load. A ticket page is issued, and the terminal 101 receives the screen 601, which displays the service initiation time 206 in the ticket information. In this embodiment, the ticket ID 205 is passed on to the terminal 101 using a cookie, a feature specific to the Web. Use of a cookie permits information to be passed back and forth between the terminal 101 and the ticket control mechanism outside the user's awareness.

If a ticket ID is output to the screen, as in the first embodiment (FIG. 1), the terminal 101 is temporarily denied access to the computer 103 until the service initiation period. The ticket remains valid until the service initiation period even if a different terminal is able to get through in the interim. As shown in FIG. 6, the terminal 101, which receives screen 601, knows that services cannot be received until the service initiation time 206, thus reducing the number of unnecessary requests. Then, another login request to the product purchase site is sent by way of the link 605 from the login page of the product purchase site. The difference between the screen 602 and the screen 501 is the use of cookie settings in the web browser. This difference is also indicated by the link 504 and the link 605.

The ticket control mechanism 102 checks the ticket. If the ticket is found to be consistent or valid, the login request is sent to the service provider system 103 which sends the login screen 603 to the terminal 101. After the user logs in, the terminal 101 can move to the standard service screen 604.

In conventional service provider systems, the extent to which the Web system should be upgraded is not known since it is not possible to determine the number of users who attempted and gave up on access. However, with the present invention an index for performance upgrade can be obtained by analyzing the ticket history storage device 410.

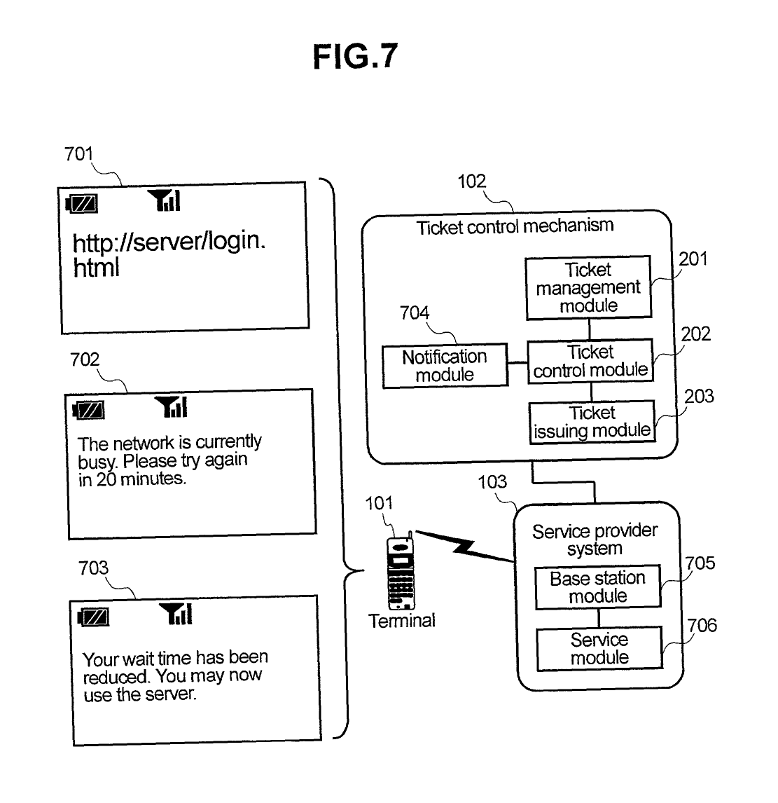

In a third embodiment of the present invention, as shown in FIG. 7, the terminal itself can be specified by the service provider system 103. In the specific embodiment shown, a mobile phone is used as an example of a terminal that can be specified by the service provider system 103.

FIG. 7 shows an architecture in which a mobile phone is used as the terminal 101. Screens 701 to screen 703 are images from the screen on the terminal 101. The ticket control mechanism 102 is formed as shown in FIG. 2, with the addition of a notification module 704. The service provider system 103 includes a base station module 705 for mobile phones and a service module 706 for mobile phone network services. The screen 701 is a screen for initiating a network service.

The terminal 101 of this embodiment sends a terminal-specific address, which is specific to the terminal, to the service provider system 103. Because this is a mobile phone, the telephone number of the terminal can be used. The screen 702 is displayed when the service module 706 is experiencing a heavy load and the terminal 101 receives a ticket from the ticket issuing module 203. The notification system is also activated when a system has an insufficient number of base station circuits. Furthermore, if a telephone number is specified, a voice announcement rather than a display screen can be used.

The screen 703 is displayed on the terminal 101 when a reduced wait notification is received from the ticket control mechanism 102 due to a lightening of the load on the service provider system 103 that was earlier than expected. The reduced wait notification can be sent to the notification module 704 by having the ticket control mechanism 102 retrieve load information at a fixed interval or by having the service provider system send a notification when there is a drop in the load.

This embodiment of the present invention allows a service provider system to be used efficiently and provides reduced waiting time for the user of the terminal 101. If the number of simultaneous accesses to the service provider system or the number of requests per unit time is greater than expected, individual terminals can be notified of a time at which the service will be available. Thus, the requests that would otherwise be concentrated on the server site can be distributed over time so that the load on the server site can be controlled. With this service provider system, the system load generated by providing services can be decreased, reduced responsiveness to individual requests can be avoided, and server system shutdowns can be prevented. Since conventional systems do not provide a record of customers who give up service access due to reduced responsiveness in the service provider system or customers that could not access the service provider system due to system shutdowns, no index for appropriate performance upgrades can be provided. In contrast, the present invention leaves a record of issued tickets that can be used as an index for performance upgrades.

With the present invention, multiple computer access to a service provider system can be balanced.

Therefore, while the description above provides a full and complete disclosure of the preferred embodiments of the present invention, various modifications, alternate constructions, and equivalents will be obvious to those with skill in the art. Thus, the scope of the present invention is limited solely by the metes and bounds of the appended claims.

What is claimed is:

1. A control method for controlling a load on a second system, the method comprising:
receiving a service initiation request from a first system;
determining a load level of the load on the second system in response to the service initiation request from the first system; and
generating, based upon the load level of the load on the second system determined in response to the service initiation request from the first system, a ticket containing an identifier associated with the service initiation request from the first system and a service initiation period during which service can be provided by the second system to the first system.

2. A method as recited in claim 1 wherein the service initiation period is selected to reduce overloading the second system to a load level beyond a permissible load level.

3. A method as recited in claim 1 wherein the first system has priority of access to the second system during the service initiation period over a third system which does not have a ticket corresponding to the service initiation period contained in the ticket of the first system.

4. A method as recited in claim 1 further comprising sending the ticket to the first system.

5. A method as recited in claim 5 wherein the ticket is sent to the first system as a cookie.

6. A method as recited in claim 1 further comprising storing ticket generating information of the generating step as a ticket generating history.

7. A method as recited in claim 1 further comprising sending a wait reduction notice to the first system if a service initiation time for the second system is available earlier than indicated in the service initiation period contained in the ticket for the first system.

8. A method as recited in claim 1 further comprising initiating a service request with the second system for the first system, if the load level of the load on the second system determined in response to the service initiation request is below a preset threshold load level, without generating a ticket.

9. A control method for controlling a load on a second system, the method comprising:
receiving a service initiation request and a ticket from a first system, the ticket containing an identifier associated with the service initiation request from the first system and a service initiation period during which the first system has a priority of access for the first system to the second system over a third system which does not have a ticket corresponding to the service initiation period contained in the ticket of the first system; and
initiating a service request with the second system for the first system, if the identifier is valid and if the service initiation request is received during the service initiation period contained in the ticket.

10. A method as recited in claim 9 further comprising sending an error message to the first system if the identifier is invalid or if the service initiation request is received outside of the service initiation period contained in the ticket.

11. A method as recited in claim 10 further comprising, if the identifier is invalid or if the service initiation request is received outside of the service initiation period contained in the ticket:
determining a load level of the load on the second system in response to the service initiation request from the first system;
initiating a service request with the second system for the first system, if the load level of the load on the second system determined in response to the service initiation request is below a preset threshold load level; and
generating, if the load level of the load on the second system determined in response to the service initiation request is above the preset threshold load level, a ticket containing an identifier associated with the service initiation request from the first system and a service initiation period during which service can be provided by the second system to the first system, based on the load level of the load on the second system determined in response to the service initiation request from the first system.

12. A control method for controlling a load on a second system, the method comprising:
sending a first service initiation request from a first system to a ticket control system;
receiving from the ticket control system, in response to the first service initiation request, a ticket containing an identifier associated with the first service initiation request from the first system and a service initiation period during which service can be provided by the second system to the first system;
sending a second service initiation request with the identifier associated with the first service initiation request from the first system to the ticket control system; and
receiving service from the second system when the second service initiation request is sent by the first system within the service initiation period indicated by the ticket.

13. A method as recited in claim 12 wherein the ticket is sent with the second service initiation request from the first system to the ticket control system.

14. A control method for controlling a load on a second system, the method comprising:
receiving a request by the second system from a ticket control system requesting load information of the second system based on a service initiation request by a first system; and
sending the load information of the second system to the ticket control system, the load information to be used to determine a load level of the load on the second system and a time period during which service can be provided by the second system to the first system based on the load level of the load on the second system.

15. A method as recited in claim 14 further comprising:
receiving a service initiation request from the first system via the ticket control system in the time period during which service can be provided by the second system to the first system as determined based on the load level of the load on the second system; and
sending a service initiation response to the first system in response to the service initiation request.

16. A control system comprising:
a ticket issuing module that generates a ticket containing an identifier associated with a first service initiation request received from a first system and a service initiation period during which service can be provided by a second system to the first system; and
a ticket control module that allows service initiation for the first system with the second system when a second service initiation request is received from the first system with the identifier associated with the first service initiation request during the service initiation period.

17. A control system as recited in claim 16 wherein the service initiation period is selected to reduce overloading the second system to a load level beyond a permissible load level.

18. A control system comprising:
means for generating a ticket containing an identifier associated with a first service initiation request from a first system and a service initiation period during which service can be provided by a second system to the first system;
means for sending the ticket to the first system;
means for entering information relating to the ticket into a ticket management database;
means for allowing service initiation if a second service initiation request is received with the identifier associated with the first service initiation request from the first system during a time within the service initiation period as entered into the ticket management database; and
means for initiating a service request with the second system for the first system if the service initiation is allowed.

19. A control system as recited in claim 18 further comprising means for treating a third service initiation request containing an identifier which has not been entered in the ticket management database in a manner as a new request with a lower priority than the second service initiation request.

20. A computer-readable storage medium storing a control program for controlling a load on a second system, the control program comprising:
code for determining a load level of a load on the second system in response to a service initiation request from a first system; and
code for generating, based upon the load level of the load on the second system determined in response to the service initiation request from the first system, a ticket containing an identifier associated with the service initiation request from the first system and a service initiation period during which service can be provided by the second system to the first system.
